(19) United States
(12) Patent Application Publication
(10) Pub. No.: US 2013/0076941 A1
(43) Pub. Date: Mar. 28, 2013

(54) Systems And Methods For Editing Digital Photos Using Surrounding Context

(71) Applicants: Virgil Artimon Palanciuc, Bucharest (RO); Andrian Cucu, Bucharest (RO)

(72) Inventors: Virgil Artimon Palanciuc, Bucharest (RO); Andrian Cucu, Bucharest (RO)

(73) Assignee: Adobe Systems Incorporated, San Jose, CA (US)

(21) Appl. No.: 13/242,228

(22) Filed: Sep. 23, 2011

(51) Int. Cl. H04N 5/262; H04N 5/76

(52) U.S. Cl. 348/231.99; 348/239; 348/E05.056; 348/E05.024

(57) ABSTRACT

Systems and methods for multi-pressure interaction on touch-sensitive surfaces are disclosed. One disclosed embodiment of a system includes a display; a memory configured to store images; a camera in communication with the memory, the camera configured to capture images; and a processor in communication with the memory and the display. In this embodiment, the processor is configured to receive a first image; receive a selection of a portion of the first image, wherein the portion is less than all of the first image; receive a second image, the second image comprising a different image than the first image; determine a portion of the second image corresponding to the portion of the first image; and replace the portion of the first image with the portion of the second image.

### FIELD

The present disclosure relates generally to editing photos and more specifically relates to systems and methods for editing digital photos using surrounding context.

### BACKGROUND

Handheld digital cameras have become relatively inexpensive and easy to use and are now widely used as a convenient way to take pictures. Such handheld digital cameras typically include storage for hundreds or more pictures on a small removable memory device and allow the user to browse photos that have been taken and delete any that are unsatisfactory.

Digital cameras have even been incorporated into other devices, such as cellular telephones, laptop computers, smartphones, and tablet computers. Despite the prevalence of such devices, photo editing functionality on such devices is typically limited to deleting and retaking photos. For example, if a person takes a photograph, but accidentally covers part of the lens with his thumb, his only option will typically be to retake the picture. This is not ideal as in some cases it may be very difficult or impossible to recreate the scene from the original photo. And while some cameras allow a user to create simulated panorama photographs based on multiple successive pictures of different parts of a larger scene, such technology does not allow a user to edit a photo, but only to stitch multiple photos together to create a larger image.

### SUMMARY

Embodiments disclosed herein provide systems and methods for editing digital photos using surrounding context. For example, one embodiment disclosed herein is a device comprising a camera, a display, memory for storing images, and a processor. In this illustrative embodiment, the processor is configured to receive a first image; receive a selection of a portion of the first image; receive a second image, the second image comprising a different image than the first image; determine a portion of the second image corresponding to the portion of the first image; and replace the portion of the first image with the portion of the second image.

This illustrative embodiment is mentioned not to limit the disclosure, but rather to provide an example to aid understanding thereof. Illustrative embodiments are discussed in the Detailed Description, which provides further description of various embodiments. Advantages offered by various embodiments may be further understood by examining this specification.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 shows an embodiment of a system for editing digital photos using surrounding context;

FIGS. 2A-B show embodiments of systems for editing digital photos using surrounding context;

FIGS. 3A-B show embodiments of methods for editing digital photos using surrounding context;

FIGS. 4A-G show simulated digital photos edited using surrounding context according to a disclosed system and method; and

FIGS. 5A-E show simulated digital photos edited using surrounding context according to a disclosed system and method.

### DETAILED DESCRIPTION

Example embodiments are described herein in the context of systems and methods for editing digital photos using surrounding context. An example system according to the present disclosure is a mobile device capable of taking digital photo. If a photo is taken but is undesirable for some reason, such as showing a thumb partially covering the lens of the camera, a photography application executing on the mobile device allows the user to manually select the undesired portion of the photo. The photography application then allows the user to take a second photo to correct the defect in the first photo. While the user is preparing to take the second photo, the photography application displays a preview of the first photo with the camera viewfinder image overlaid on the first photo to assist the user in aligning the camera to take the second photo. The photography application then blends the two photos to create a new photo with no unwanted artifacts.

Those of ordinary skill in the art will realize that the preceding example and the following description are illustrative only and are not intended to be in any way limiting. Other embodiments will readily suggest themselves to such skilled persons having the benefit of this disclosure. Reference will now be made in detail to implementations of example embodiments as illustrated in the accompanying drawings. The same reference indicators will be used throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

An example system according to the present disclosure is a mobile device capable of taking digital photo. If a photo is taken but is undesirable for some reason, such as showing a thumb partially covering the lens of the camera, a photography application executing on the mobile device allows the user to manually select the undesired portion of the photo. The photography application then allows the user to take a second photo to correct the defect in the first photo. While the user is preparing to take the second photo, the photography application displays a preview of the first photo with the camera viewfinder image overlaid on the first photo to assist the user in aligning the camera to take the second photo. The photography application then blends the two photos to create a new photo with no unwanted artifacts.

### Illustrative System for Editing Digital Photos Using Surrounding Context

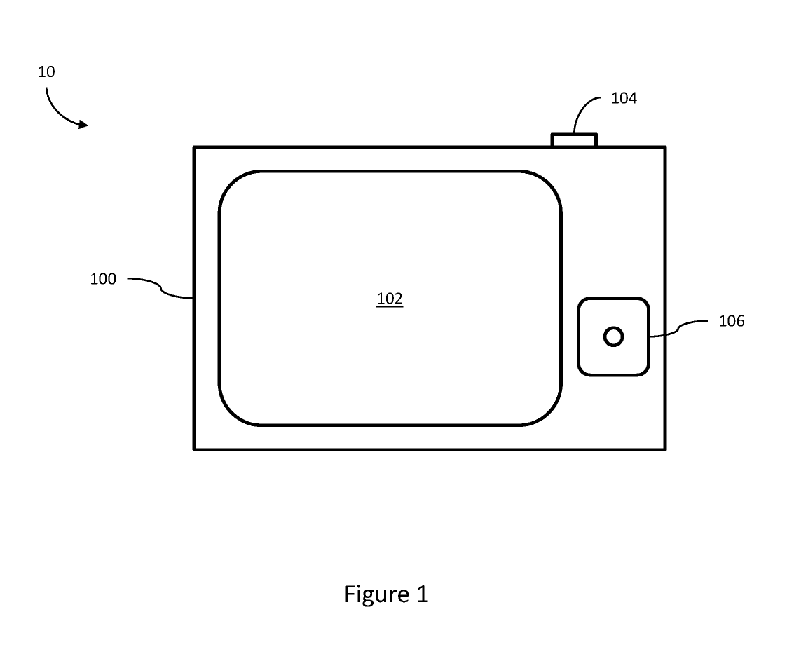

FIG. 1 shows an embodiment of an illustrative system 10 for editing digital photos using surrounding context. The system 10 shown includes a handheld digital camera 100, which is pictured from the rear. The camera 100 includes an LCD touch-sensitive display screen 102, a shutter button 104 for taking a picture, and a user input device 106 for selecting configuration options or viewing captured images. The camera 100 also includes a lens on the front side of the camera 100, which is not shown. The camera 100 includes application software to allow a user to edit photographs taken by the camera 100. For example, after the user uses the camera 100 to take a picture of a scene, the picture is displayed on the display screen 102 for the user to view. If the image includes an undesirable artifact or object such as a the user's thumb, or a person walking through the frame, the user may identify the portion of the image with the undesired artifact or object. For example, the user may use a finger to touch the display screen 102 and draw a boundary around the undesired artifact or object on the image. Or the user may use the user input device 106, a D-pad (or directional pad) in this example, to perform a similar maneuver. The user may then take a second picture of the scene, typically from approximately the same viewpoint as the first picture to provide context to replace the undesired artifact or object.

In this case, however, rather than displaying the second image, the camera 100 continues to display the first image, but allows a portion of the second image to be overlaid on (or be seen through) the selected portion of the first image. Thus, the camera 100 displays a composite image based on the first image and the second image, with a part of the second image replacing the selected portion of the first image, e.g. the user's thumb. In this embodiment, the camera performs an analysis on the two images to align the first image and the second image such that the visible portion of the second image fills in the selected portion of the first image. However, the user may also maneuver the second image to obtain the desired alignment between the two images. After aligning the two images, the user can effectively erase the undesired artifact or object and replace it with image data from the second image to provide a new image of the scene that appears to have been taken naturally in a single photograph. The camera 100 then stitches the two images together, such as by using known image stitching techniques, to provide a substantially seamless integration of the two images into a new composite image.

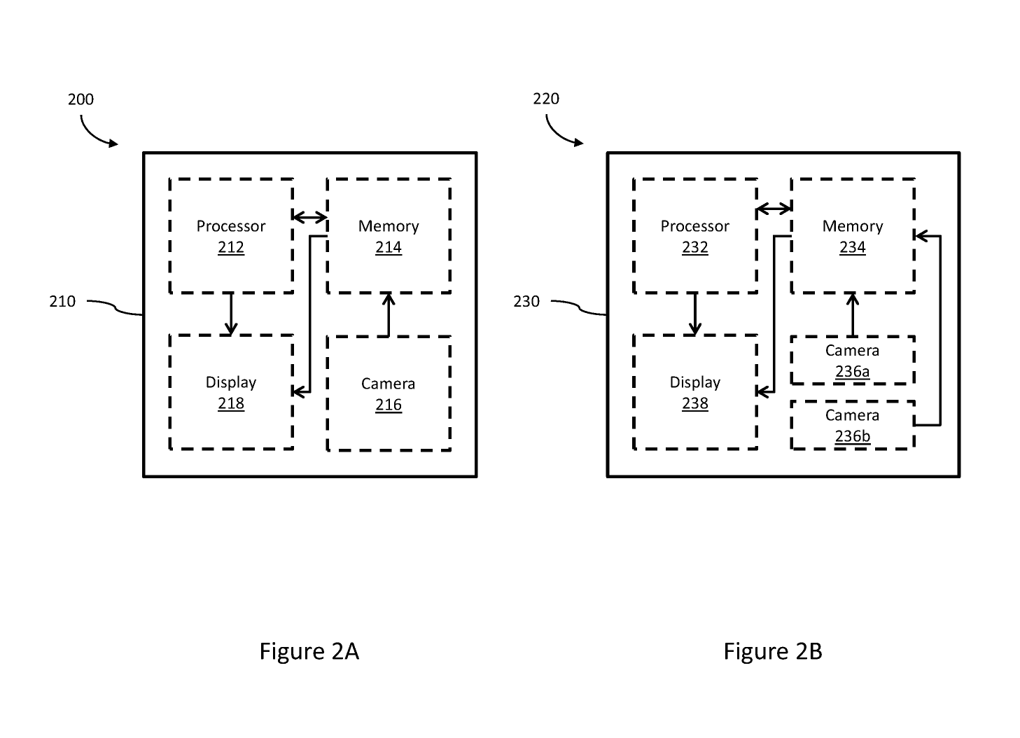

Referring now to FIG. 2A, FIG. 2A shows an embodiment of a system 200 for editing digital photos using surrounding context. In the embodiment shown in FIG. 2, the system 200 is a portable image capture device and comprises a housing 210 in which are disposed a processor 212, memory 214, a camera 216, and a display 218. In some embodiments, the housing 210 is configured to be a handheld camera device, such as a digital camera or a digital single-lens reflex camera. In some embodiments, the housing 210 is a housing for other handheld devices, such as smartphones, tablets, or cellular phones. The term portable image capture device is intended to refer to portable devices capable of capturing digital images by one or more cameras and storing. Thus, for example, handheld digital cameras, cell phones (including smartphones) with cameras, and handheld tablet computers with cameras are all portable image capture devices for the purposes of this disclosure.

In the embodiment shown, the processor 212 is in communication with memory 214 and is configured to execute processor-executable instructions stored in memory 214. The camera 216 is in communication with memory 214 and is configured to capture images of scenes and to store them in memory 214. Within the context of this disclosure, the term ‘scene’ generally refers to a portion of reality visible from a viewpoint in a particular direction. While scenes include objects that are visible from a large number of different perspectives, for the purposes of this disclosure, when the specification refers to multiple images of the same scene, the images of the scene result from substantially the same viewpoint in substantially the same direction. It is generally extremely difficult to capture two images from precisely the same viewpoint in precisely the same direction, therefore, while images discussed throughout the disclosure may have slightly different viewpoints and directions, they may be considered images of the same scene. Note that while the rotation of a camera about an axis along the direction will affect the orientation of a resulting image, the image may still be of the same scene as the image may be rotated to obtain a similar image as others taken from other rotational orientations.

Referring again to FIG. 2B, in this embodiment, memory 214 comprises volatile random-access memory (RAM) and non-volatile flash memory. Program code is stored on the flash memory and loaded into RAM for execution by the processor 212. In this embodiment, the flash memory is embodied within a flash memory card that is removably coupled to the system 200. In addition, the camera 216 captures images and stores the images to RAM prior to the images being copied to flash memory for longer-term storage. In some embodiments, the processor 212 is also in communication with the camera 216 and may be configured to cause the camera to capture one or more images and to store the images into memory 214. The processor 212 is also in communication with the display 218 and is configured to generate and transmit a signal to cause the display to display one or more images.

In the embodiment shown in FIG. 2A, the display 218 is a touch-sensitive display and is configured to display images or video and to receive touch inputs from a user. Upon receiving a touch input, the display 218 is configured to transmit a touch signal to the processor with one or more parameters indicating the touch input. In one embodiment, the display 218 is a multi-touch display and is configured to receive multiple substantially simultaneous contacts with the display and to generate one or more touch signals associated with the multiple substantially simultaneous contacts and to transmit such one or more touch signals to the processor 212. The processor 212 is configured to receive such signals and determine inputs or gestures based on the contacts, and is further configured to determine actions responsive to such inputs and gestures.

In some embodiments, the system 200 may include additional components, such as additional input devices, such as buttons, directional pads, switches, or touch-sensitive input devices. For example, in one embodiment, the system includes a shutter button to cause the camera to capture an image, and a directional pad configured to allow the user to navigate amongst a plurality of captured images stored in memory 214, to select various options to configure image capture parameters, or to otherwise allow the user to interact with the system 200.

Some embodiments according to the present disclosure may comprise a plurality of cameras. For example, the system 220 shown in FIG. 2B comprises two cameras 236a,b, which are disposed on the same surface of the housing such that each camera 236a,b is facing substantially the same direction. For example, in one embodiment, the two cameras 236a,b are configured to capture images substantially simultaneously to provide stereoscopic images of a scene. In some embodiments, more than two cameras may be provided to capture one or more images in succession or substantially simultaneously.

As is understood in the art, digital images may be represented by one or more pixels, and a size of a digital image is typically described by the length and width of an image as a number of pixels (e.g. 1900×1200). Digital images may be stored in a variety of formats, including compressed and uncompressed formats. For example, a digital camera may capture and store an image in an uncompressed format, such as in a bitmap. Alternatively, some digital cameras capture and store images in a compressed image format, such as a JPEG format. This disclosure is not intended to be limited to images captured or stored in a particular format or by a particular method. Examples or embodiments described throughout this specification may discuss a particular image format or structure for ease of understanding, not to limit the scope of the disclosure in any way.

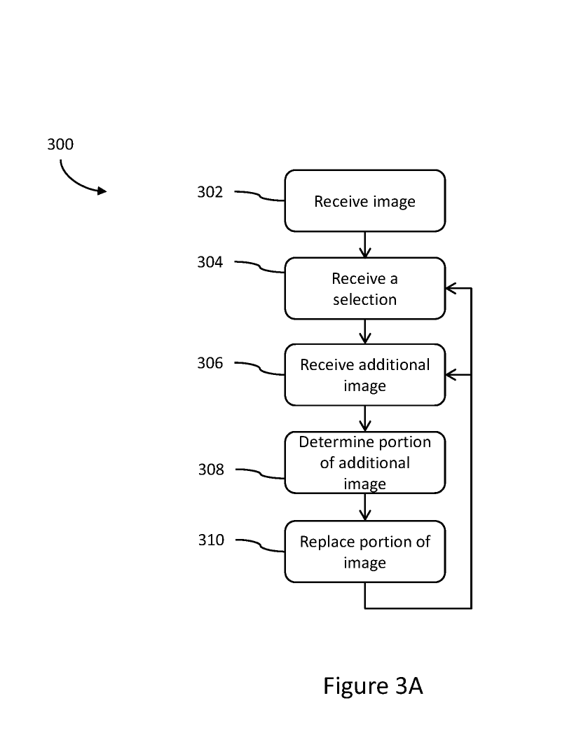

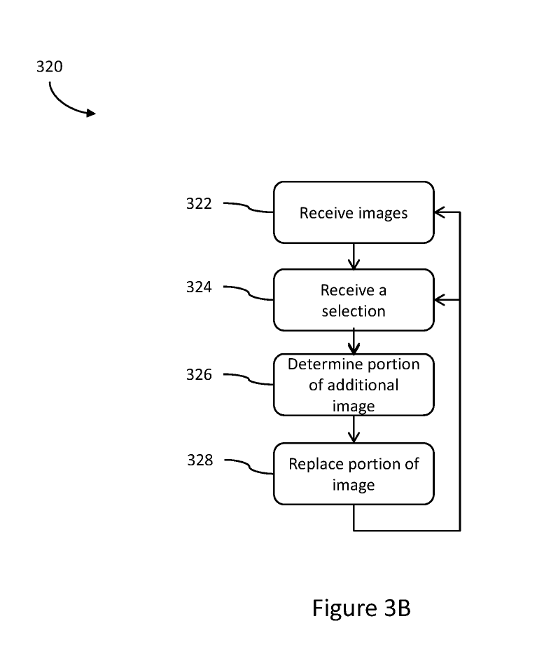

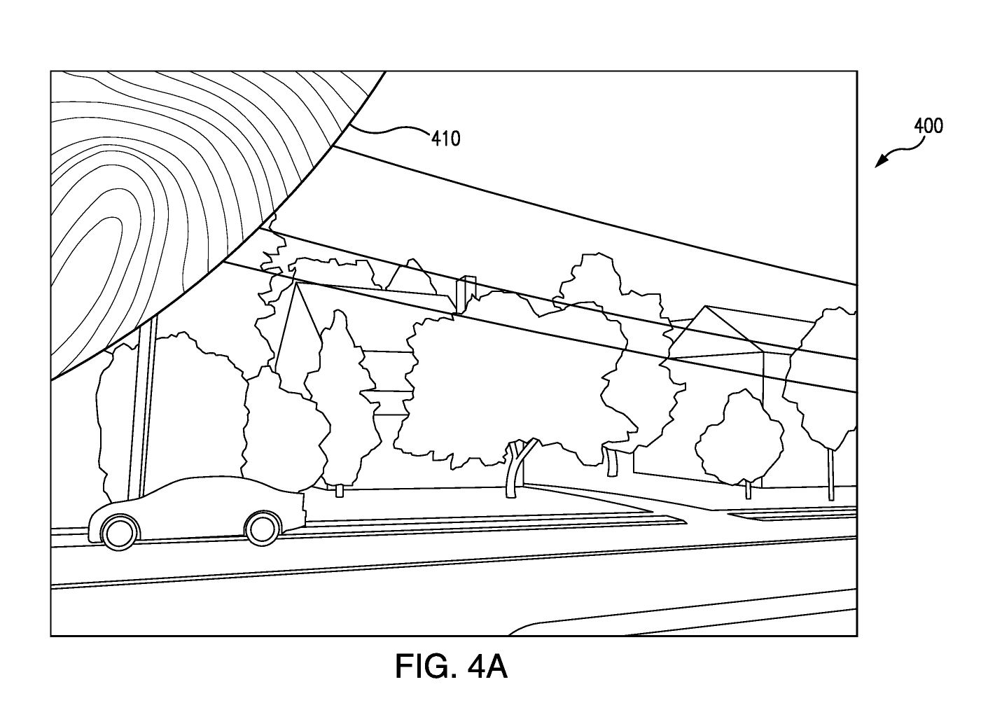

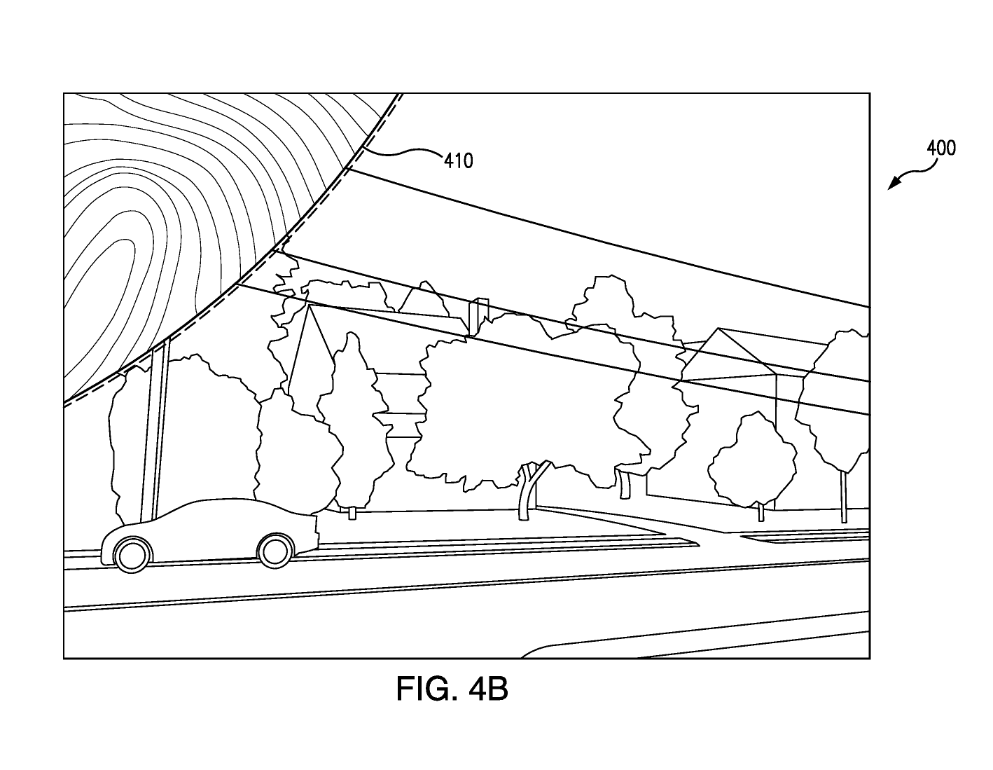

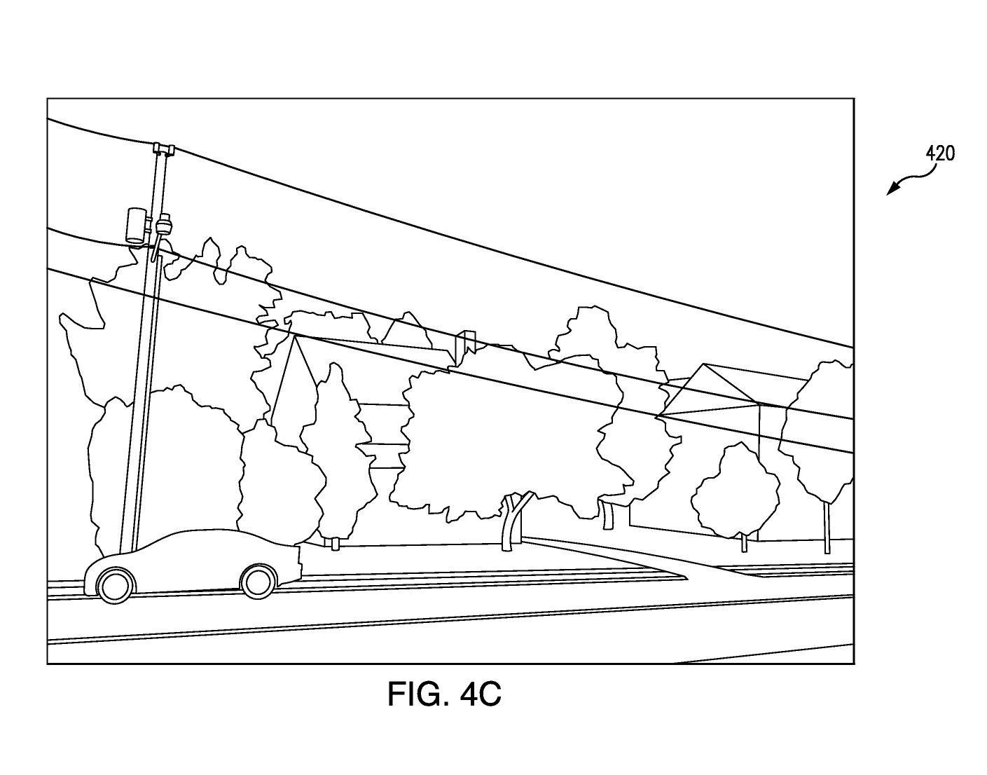

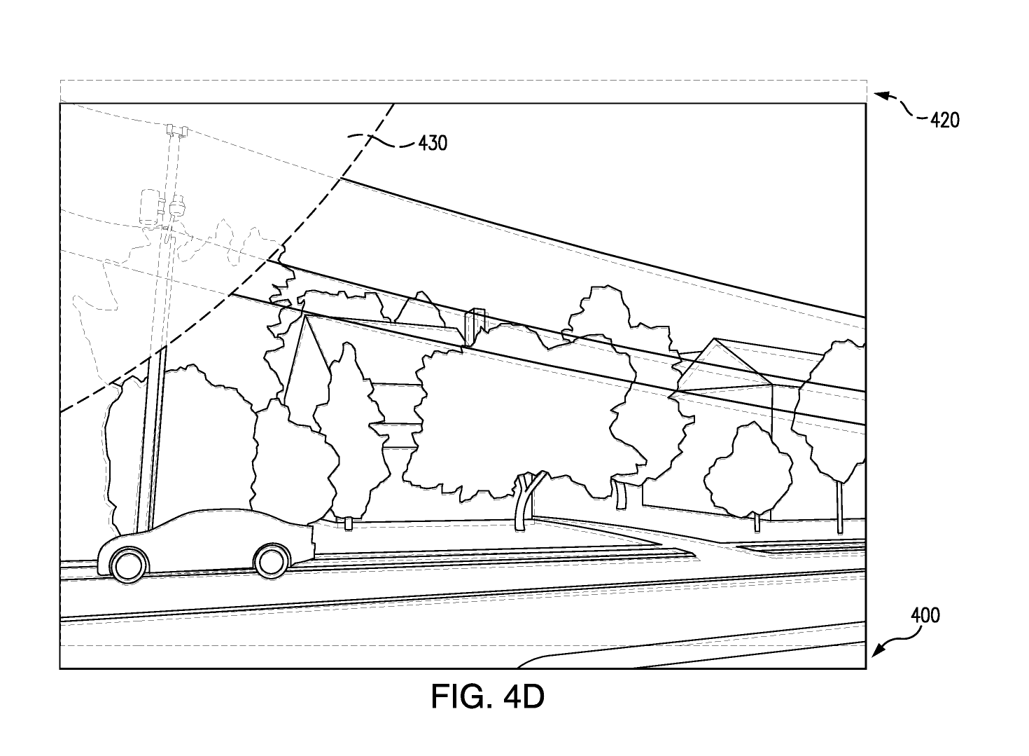

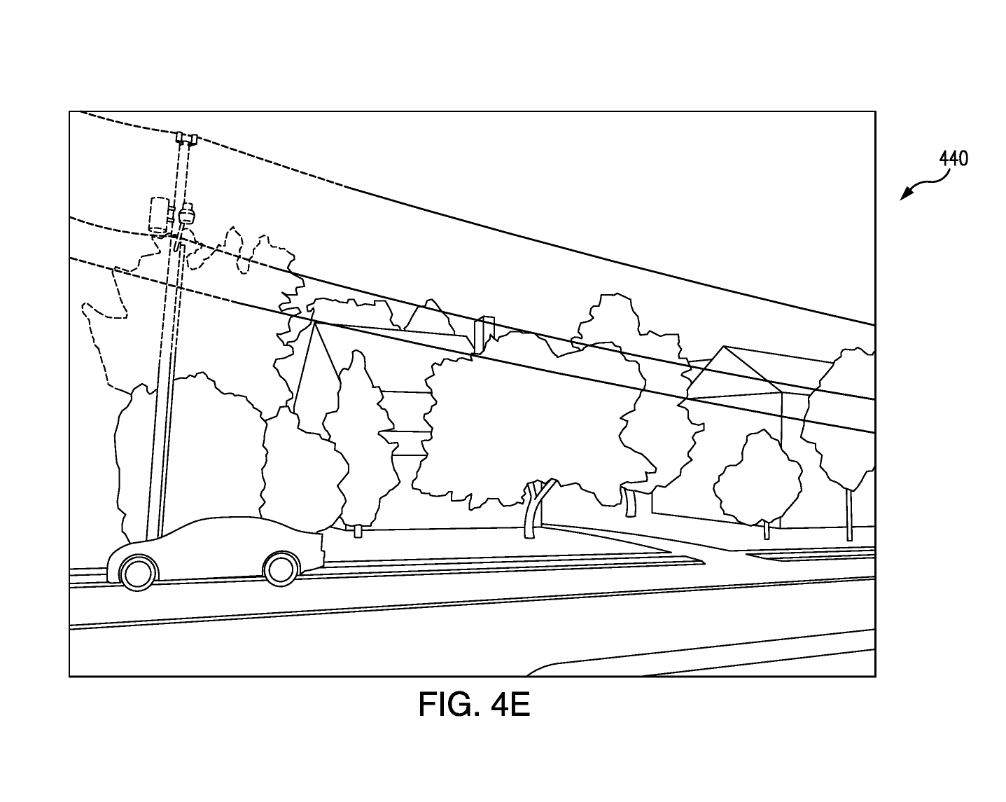

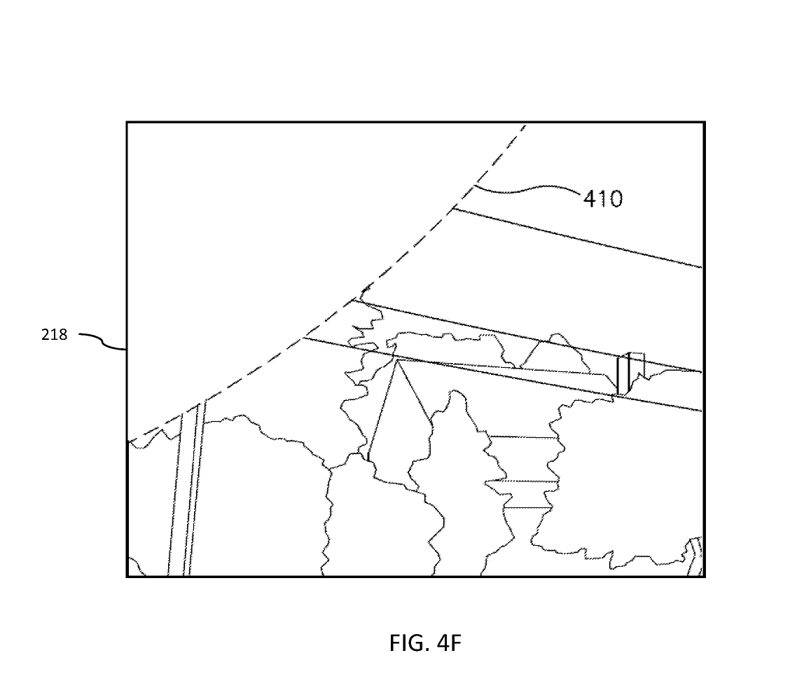

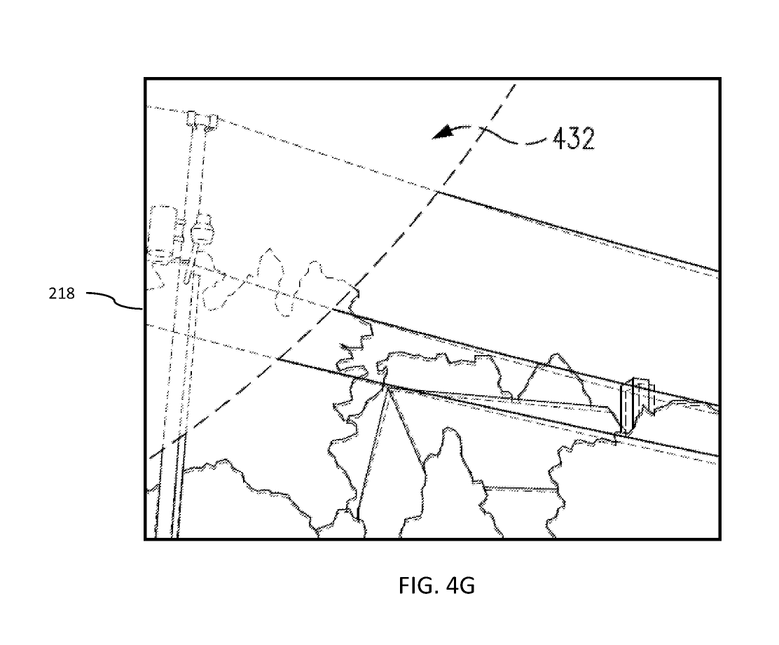

Referring now to FIG. 3A, FIG. 3A shows an embodiment of a method 300 for editing digital photos using surrounding context. The following description of method 300 will be made with reference to the system 200 shown in FIG. 2A and the simulated photos shown in FIGS. 4A-E; however, embodiments are suitable for use with this and other systems consistent with the scope of this disclosure, such as system 220 shown in FIG. 2B. Further, the ordering of steps of the method 300 shown in FIG. 3A are merely illustrative. The steps may be performed in other orders, some of which are described below. However, no limitation on the present disclosure should be implied based on the following illustrative method 300.

In the embodiment shown in FIG. 3A, the method 300 begins in block 302 when the processor 212 receives an image. In this embodiment, the camera 216 captures an image, such as the image 400 shown in FIG. 4A, and stores it to memory 214. The processor 212 subsequently receives the image 400 from memory 214, such as by receiving a memory address corresponding to the image 400. In a similar embodiment, the processor 212 receives a memory address of the image 400 stored in non-volatile memory, such as a flash memory card, and copies the image 400 from non-volatile memory into RAM and receives a memory address corresponding to the copy of the image 400 in RAM.

In some embodiments, the processor 212 may receive an image that was not captured by the camera 216. For example, in one embodiment, the system 200 may receive a flash memory card having one or more images stored on it. The processor 212 may then receive one or more addresses associated with one or more of the images stored on the flash memory card. In some embodiments, a user may use an input device to select an image stored in memory 214. In such an embodiment, the processor 212 may receive the image based on the selection. In some embodiments, after receiving the image, the processor 212 may generate a display signal configured to cause the display 218 to display the received image and transmit the display signal to the display. After receiving the first image 400, the method 300 proceeds to block 304.

At block 304, the processor 212 receives a selection of a portion of the first image 400, wherein the selected portion of the first image 400 is less than the whole first image 400. For example, in one embodiment, the first image 400 comprises an image of a scene with portion having an undesired object: a thumb that covered a part of the lens when the image was captured. Thus, in some embodiments, a user may select a portion of the first image 400 corresponding to the undesired object. For example, in the system 200 shown in FIG. 2, the user may touch the display 218 and draw a boundary around a portion of the image 400 by dragging their finger or another object, such as a stylus, on the display.

In some embodiments, a user may select a portion of the image by touching the display 218 at a location corresponding to the undesired portion of the image. In one such embodiment, the display 218 may generate and transmit a touch signal to the processor 212 with one or more parameters associated with the location of the contact. The processor 212 may then determine a location within the image corresponding to the location of the contact. The processor 212 may then perform image analysis to identify an object within the image associated with the location of the contact and select the object. For example, in an photo intending to capture an image of two people, a third person may have inadvertently been captured in the background. Or, in another case, an image may include two people at different distances from the camera resulting in one of the people being out of focus. To select a portion of the image corresponding to the third person, a user may touch the display 218 at a location corresponding to the image of the third person. The processor 212 receives a touch signal from the display indicating the location of the contact and determines a corresponding location on the image. The processor 212 then performs an analysis of the image and identifies the third person as a visual object within the image and selects pixels within the image corresponding to the visual object (i.e. the third person in this example), thereby selecting a portion of the first image.

In some embodiments, the camera may automatically identify such undesirable artifacts or objects, such as a thumb or finger over a part of a lens or an object that is out of focus. In one such embodiment, the system 200 is configured to automatically detect one or more undesirable artifacts or objects within an image and to select any such detected artifacts or objects. A user may then deselect any detected artifacts or objects or select any portion of the first image according to embodiments described herein.

As may be seen in FIG. 4B, a selection of a portion 410 of the first image 400 has been made, including the undesired thumb, as is indicated by the dotted line. In some embodiments, such as the embodiment shown in FIG. 6, after receiving a selection of a portion of the first image 400, the processor generates a display signal configured to cause the display to show an indication of the selected portion of the first image. In some embodiments, the indication may comprise an outline of the selected portion or a highlighting of the selected portion in a different color. In some embodiments, the selected portion may be displayed as transparent or displayed as missing or deleted.

In some embodiments, the processor 212 may receive selections of a plurality of portions of the image. For example, in one embodiment a user may desire to select multiple portions of the first image. In such an embodiment, the user may touch the touch-sensitive display 218 and draw a boundary around the undesired portions of the first image to select each of the multiple portions. Alternatively, the user may touch the touch-sensitive display 218 at a location corresponding to a displayed object to select the object. As was discussed above, in some embodiments, the processor 212 may generate a display signal configured to cause the display to show an indication for some or all of the selected portions of the first image. After the processor 212 receives a selection of a portion of the first image 400, the method 300 proceeds to block 306.

In block 306, the processor 212 receives a second image. In this embodiment, the second image 420 comprises an image similar to the first image 400 as the second image 420 is intended to provide image data to replace the selected portion 410 of the first image 400; however, in some embodiments, the second image may comprise an image of substantially the same scene, but under different conditions, such as different lighting, different time of day, different weather, different persons within the scene, and so forth, to provide desired image data. For example, a first image may include two persons within a scene at different distances from the camera, such that one person is shown out of focus in the image. A second image may be captured in which the person who was out of focus in the first image is captured in focus in the second image, thus allowing a user to replace the out-of-focus portion of the first image with the in-focus portion of the second image.

In some embodiments, the second image 420 may be captured and received subsequent to capturing and receiving the first image 400. For example, FIG. 4C represents an image 420 captured and received subsequent to the first image 400 being captured and received. As can be seen, the second image 420 is of substantially the same scene as was captured in the first image 400, though from a slightly different angle. In some embodiments, the portable image capture device automatically captures the second image, or additional images, substantially immediately after (or substantially immediately before) capturing the first image.

In some embodiments, a system 220 may comprise a plurality of cameras and may be configured to capture multiple images of similar subject matter substantially simultaneously. For example, system 220 comprises two cameras, which may be activated substantially simultaneously to capture first and second images. Such an embodiment may advantageously provide two images having substantially identical views of the same scene and will be described in more detail below with respect to FIG. 3B.

In embodiments having only a single forward-facing camera, it may be difficult for a user to located a suitable viewpoint from which to capture the second. Thus, in one embodiment in which a system 200 comprises a single camera facing in a direction, the system 200 provides cues to a user attempting to capture a second image. For example, the processor 212 may generate a display signal to cause the display 218 to display a partially-transparent copy of the first image 400 overlaid on the display as the user aligns the system 200 to capture the second image. Such an embodiment may be advantageous in that as the user prepares to capture the second image 420, he may better align or focus the camera to replicate the image of the scene from the first image 400.

In a similar embodiment, the processor 212 may generate a display signal to cause the display 218 to display a partially-transparent copy of the selected portion of first image 400 overlaid on the display 218, rather than the full first image 400, as the user aligns the system 200 to capture the second image. Such an embodiment may be seen in FIGS. 4F and 4G. The embodiment shown in FIG. 4F shows the display 218 displaying only a portion of the first image 400 with the selected portion 410 removed. As the user aligns the camera, the selected portion 410 is replaced in the display 218 by a live preview 432 of the scene viewed by the camera prior to capturing the image, as may be seen in FIG. 4G. This may allow the user to more easily align the camera to replace the selected portion of the first image.

In one embodiment, the processor 212 may further shift the preview of the second image to be captured to ensure that the user captures sufficient information to fully replace the selected portion of the first image. A user may capture the first image and then capture a second image such that the alignment between the first image and the second image results in the second image only having sufficient image information to partially replace the selected portion. For example, the user may align the camera too far to the left or the right. Thus, the processor 212 may analyze the location of the selected portion of the first image and translate the preview of the second image from the camera's true perspective to cause the user to orient the camera to capture sufficient information.

For example, as shown in FIG. 4B, the thumb obscures the upper left of the image. Thus, the camera may intentionally shift or misalign a preview of the second image prior to capture down and to the right such that the user will tend to compensate for the apparent misalignment by aligning the camera more upwards and leftwards to capture the utility pole. The resulting image may then have the utility pole closer to the center of the second image, thus ensuring sufficient image data is available to completely replace the area obscured by the thumb.

As was discussed with respect to block 302, in this embodiment, a camera 216 captures a second image 420 and stores it to memory 214. The processor 212 subsequently receives the second image 420 from memory 214, such as by receiving a memory address of the second image 420. However, in other embodiments, the processor 212 may receive an image that was not captured by the camera 216. For example, in one embodiment, the system 200 may receive a flash memory card having one or more images stored on it. The processor 212 may then receiving one or more addresses associated with one or more of the images stored on the flash memory card. In some embodiments, a user may use an input device to select an image stored in memory 214. In such an embodiment, the processor 212 may receive the second image 420 based on the selection. After receiving the second image 420, the method 300 proceeds to block 308.

At block 308, the processor 212 determines a portion of the second image 420 corresponding to the selected portion of the first image 400. As may be seen in FIGS. 4A and 4C, the first and second images 400, 420 comprise similar images and it may be possible to replace the selected portion of the first image with image data from the second image to eliminate the thumb that is visible in the first image. In the embodiment shown in FIG. 3A, the processor 212 previously generated and transmitted a display signal to cause the display to display the selected portion with a dashed boundary line. After receiving the second image 420, the processor 212 generates a second display signal configured to cause the first image 400 to be displayed and the selected portion to be displayed as transparent. The second display signal is also configured to cause the second image to be displayed behind the first image and thus a part of the second image 420 is displayed at a location corresponding to the transparent selected portion of the first image 400. Thus, the second display signal is configured to cause the display 218 to display a composite image 430 comprising image data from the first image 400 and the second image 420.

As can be seen in FIG. 4D, the image data from the first image 400 is configured to be displayed in an unaltered state, except for the selected portion 410, which is not displayed. Instead, image data from the second image 420 is visible instead of image data from the selected portion 410 of the first image 400. Further, because the second image 420, while an image of the same scene, comprises a different image than the first image 400, the alignment of the second image 420 to the first image 400 may be adjusted to allow a substantially seamless interface between image data from the first image 400 and image data from the second image 420.

For example, in this embodiment, the processor 212 determines a portion of the second image 420 corresponding to the selected portion 410 of the first image 400 based on an input received from an input device. For example, the user can touch the display 218 and drag or rotate the second image to obtain a desired alignment between the first image 400 and the second image 420. As may be seen in the composite image 430 in FIG. 4D, the second image has been offset slightly to achieve a substantially seamless interface between the first image and the second image such that the image of the thumb in the first image has been replaced by the utility pole shown in the second image that had been previously obstructed. In some embodiments, the user may be able to use additional gestures to achieve a desired alignment and correspondence between the first image 400 and the second image 420. For example, in one embodiment, a user can perform gestures to change a zoom level on the second image 420 or to stretch or distort the second image 420 or a portion of the second image 420. Thus, various manipulations of the second image 420 may occur to provide an appropriate alignment with the first image 410, including, for example, rotation, translation, or scaling.

In some embodiments, the processor 212 determines a portion of the second image 420 corresponding to the selected portion of the first image 400, such as without input from a user after receiving the second image 420. For example, in one embodiment, the processor 212 executes an image alignment and stitching algorithm configured to identify relationships and overlap between the first and second images 400, 420, to align the first and second images 400, 420 based on the identified relationships and overlap, and to blend first and second images 400, 420 such that the selected portion of the first image 400 is replaced by a corresponding portion of the second image 400. After the portion of the second image 420 has been determined, the method proceeds to block 310.

At block 310, the processor 212 replaces the selected portion 410 of the first image 400 with the determined portion of the second image 420. In the embodiment shown in FIG. 2A, the processor 212 generates a third image 440 comprising the first image 400 except for the selected portion 410, which is replaced by the determined portion of the second image 420. Because the selected portion 410 of the first image 400 is less than the whole image, the selected portion 410 of the first image 400 comprises image data within the dimensions of the first image 400. Thus, after the first image 400 has had the selected portion 410 replaced with image data from the second image 420, the third image 440 retains the dimensions of the first image 400 (though the third image 440 may be resized, such as by scaling). While some embodiments may result in a third image 440 with slightly different dimensions than the first image 400, the third image 440 should not substantially alter the size of the scene captured in the first image 400. In some embodiments, a distinct third image 440 may not be created. Rather, the first image 400 itself may be modified to replace the selected portion 410 of the first image 40 with the determined portion of the second image 420. Such an embodiment may require fewer memory resources as an unaltered copy of the first image 400 is not retained.

After the selected portion 410 of the first image 400 has been replaced by the determined portion of the second image 420, the method may finish, or it may return to an earlier step, such as block 304 or 306 to identify further portions of the image 400, 440 to be replaced or to capture additional images to be used to replace portions of the first image 400. Steps of the method 300 may be repeated iteratively until a desired image is obtained.

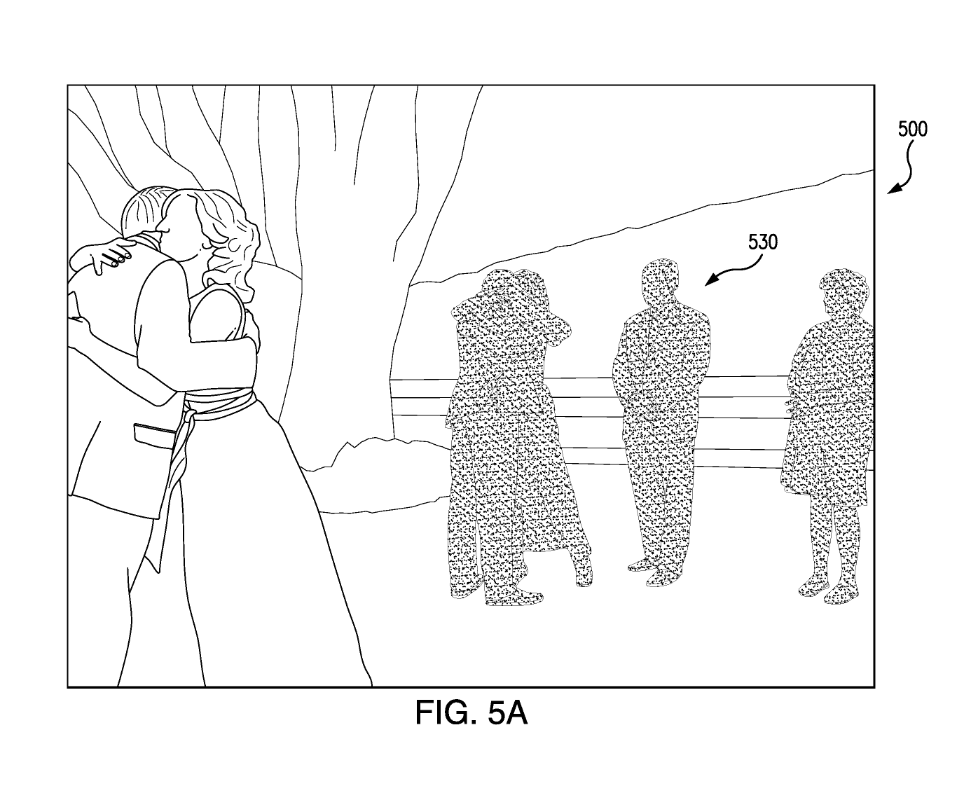

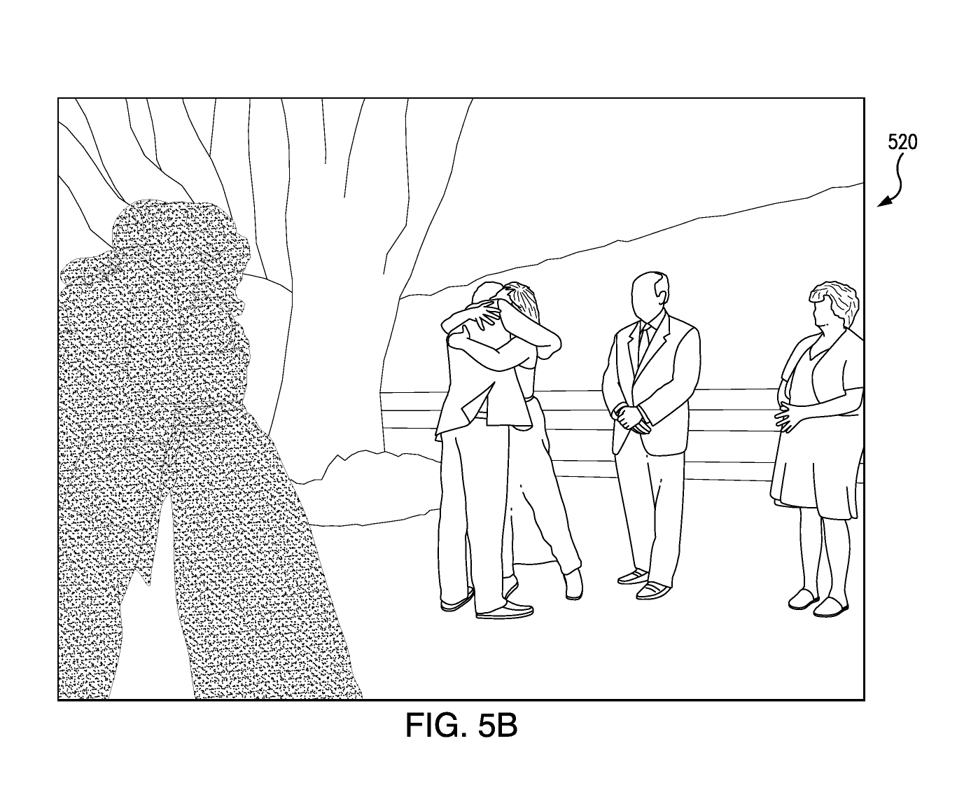

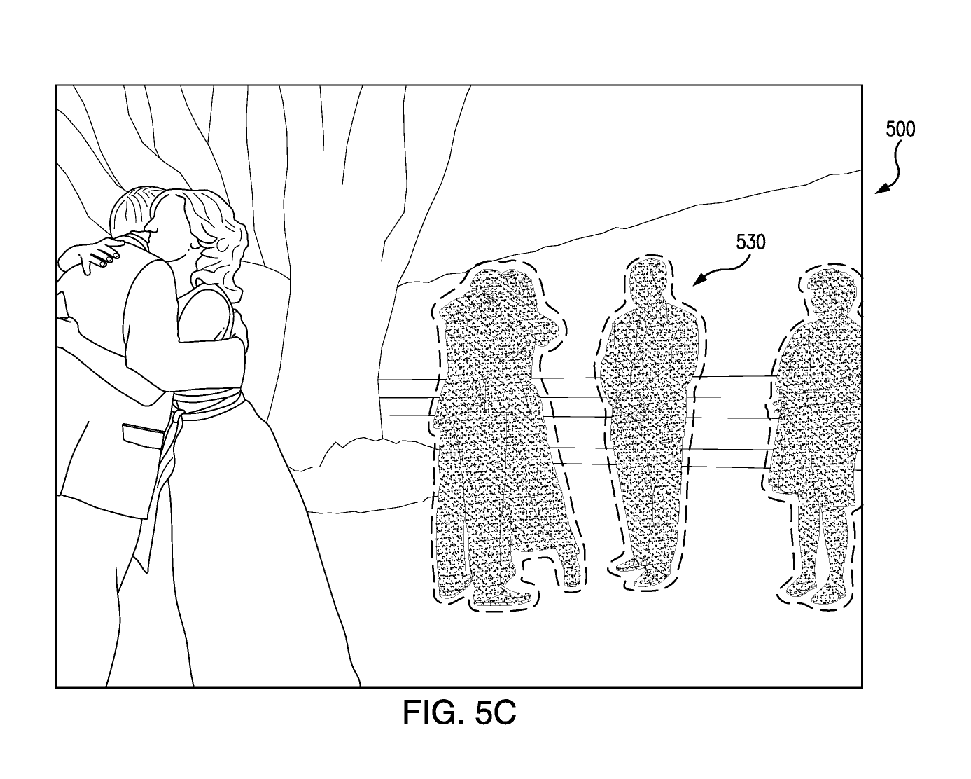

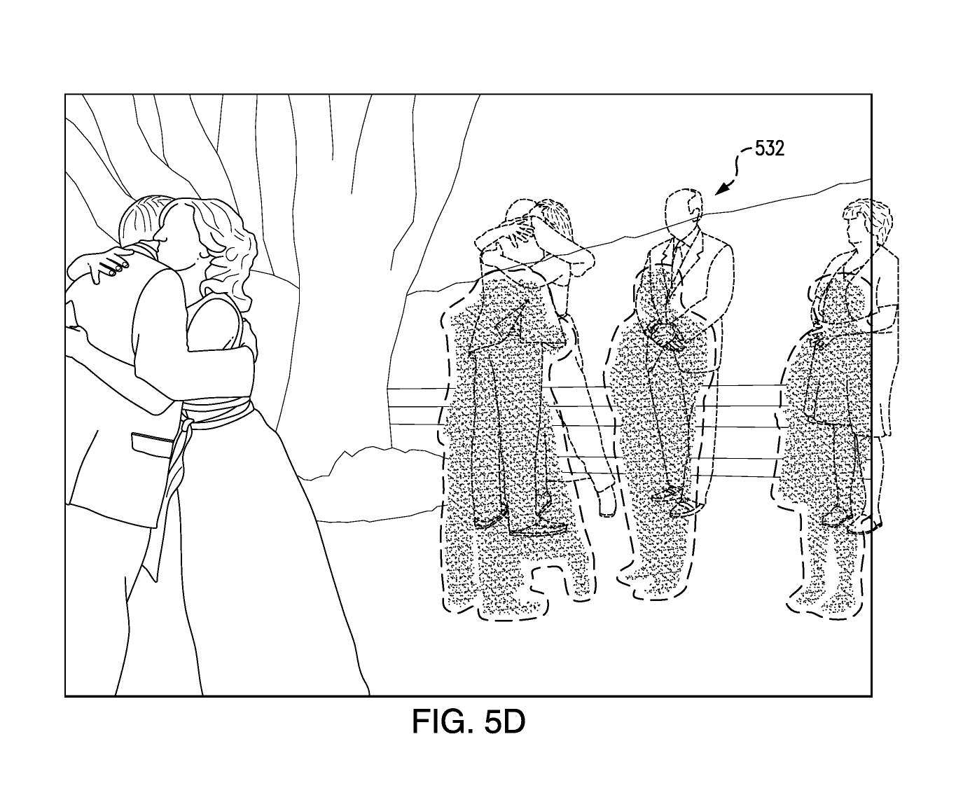

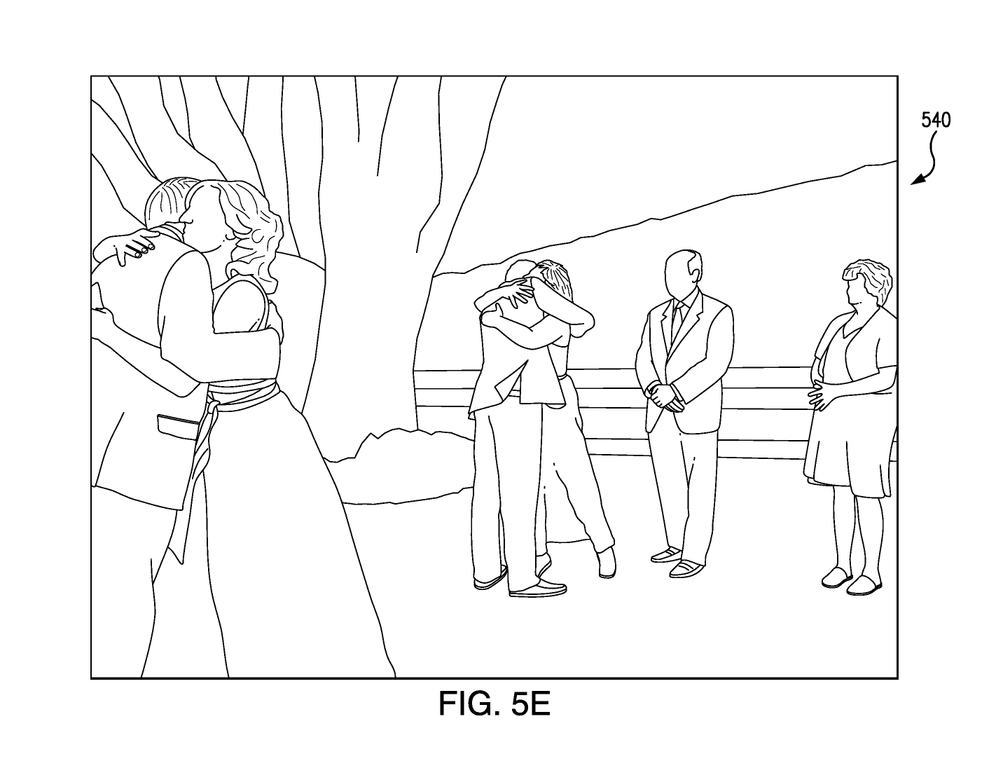

Referring now to FIG. 3B, FIG. 3B shows an embodiment of a method 320 for editing digital photos using surrounding context. The following description of method 320 will be made with reference to the system 220 shown in FIG. 2B and the simulated photos shown in FIGS. 5A-E; however, embodiments are suitable for use with this and other systems consistent with the scope of this disclosure, such as system 200 shown in FIG. 2A. Further, the ordering of steps of the method 320 shown in FIG. 3B are merely illustrative. The steps may be performed in other orders, some of which are described below. However, no limitation on the present disclosure should be implied based on the following illustrative method 320.

In the embodiment shown in FIG. 3B, the method 320 begins in block 302 when the processor 232 receives a plurality of image. In this embodiment, the portable image capture device comprises two cameras 236a,b, which are configured to capture images substantially simultaneously. In this embodiment, the cameras 236a,b are configured within device 220 such that the cameras 236a,b both face in substantially the same direction with the same orientation. The cameras 236a,b are configured to capture images of the same scene with different focal lengths; however, in some embodiments, cameras 236a,b may be similarly configured, or be configured to capture images with different settings, such as exposure time, color settings, etc. In some embodiments, the cameras 236a,b are configured to capture images in succession, or upon separate depressions of a shutter button. Note that while the embodiment shown in FIG. 3B is discussed with respect to a portable image capture device having two cameras, no limitation on the number of cameras should be inferred. Rather, portable image capture devices having 1 or more cameras may be employed according to this and other embodiments.

In this embodiment, the two cameras 236a,b each capture an image, such as the images 500, 520 shown in FIGS. 5A and 5B, respectively, and stores them to memory 234. The processor 232 subsequently receives the images 500, 520 from memory 234, such as by receiving memory addresses corresponding to the images 500, 520. In a similar embodiment, the processor 232 receives memory addresses corresponding to the images 500, 520 stored in a non-volatile memory, such as a flash memory card, and copies the image 400 from non-volatile memory into RAM and receives memory addresses corresponding to copies of the images 500, 520 in RAM.

As discussed previously, in some embodiments, the processor 232 may receive images that were not captured by the camera 236a,b. For example, in one embodiment, the system 220 may receive a flash memory card having a plurality of images stored on it. The processor 212 may then receive addresses corresponding to the images stored on the flash memory card.

In this embodiment, because multiple images are received, a user may select one of the images as a first image to be modified, such as by configuring the portable image capture device 220 such that images captured by camera 236a are first images, while images captured by camera 236b are second images. In some embodiments, the user may be able to manually select one of the images to be the first image, or the portable image capture device may determine one of the images as the first image. In this embodiment, image 500 will be referred to as the first image, though no limitation on which image comprises the first image in some embodiments should be inferred. After receiving the images 500, 520, the method 320 proceeds to block 324.

At block 324, the processor 232 receives a selection of a portion of a first image 500, wherein the selected portion of the first image 500 is less than the whole first image 500. In this embodiment, the first image 500 comprises multiple people within the image, some of which are out of focus. However, because, in this embodiment, the second image 520 was captured using a different focal depth, the people shown out of focus in the first image are in proper focus in the second image. Thus, in this embodiment, the portable image capture devices receives a selection 530 of the people that are shown as out of focus in the first image 500. After receiving the selection, the method 300 proceeds to block 326.

At block 326, the processor 232 determines a portion of the second image 520 corresponding to the selected portion of the first image 500. As may be seen in FIGS. 5A and 5B, the first and second images 500, 520 comprise similar images and it may be possible to replace the selected portion of the first image 500 with image data from the second image 520 to provide an image in which all persons in the image are in focus. In the embodiment shown in FIG. 3B, the processor 232 generates and transmits a display signal to cause the display to display the selected portion with a dashed boundary line and the selected portion to be displayed as transparent such that the second image 520 is displayed behind the first image and thus a part of the second image 520 is displayed at a location corresponding to the transparent selected portion of the first image 500. Thus, the display signal is configured to cause the display 238 to display a composite image 530 comprising image data from the first image 500 and the second image 520.

As can be seen in FIG. 5D and similar to the image shown in FIG. 4D, the image data from the first image 500 is configured to be displayed in an unaltered state, except for the selected portion 510, which is not displayed. Instead, image data 532 from the second image 520 is visible instead of image data from the selected portion 510 of the first image 500. In the image in FIG. 5D, for clarity, the image data 532 from the second image is shown offset from the selected portions of the first image. However, in this embodiment, the image data from the second image will be aligned with the selected portion of the first image as is described in more detail herein.

In this embodiment, the processor 232 determines a portion of the second image 520 corresponding to the selected portion 510 of the first image 500 based on an input received from an input device. For example, as described previously, the user can touch the display 238 and drag, rotate, zoom, or otherwise adjust the second image to obtain a desired alignment between the first image 500 and the second image 520 as described previously.

In some embodiments, the processor 232 determines a portion of the second image 520 corresponding to the selected portion of the first image 500. For example, in one embodiment, the processor 212 executes an image alignment and stitching algorithm, such as described below, configured to identify relationships and overlap between the first and second images 500, 520, to align the first and second images 500, 520 After the portion of the second image 520 has been determined, the method proceeds to block 328.

At block 328, the processor 232 replaces the selected portion 510 of the first image 500 with the determined portion of the second image 520. In the embodiment shown in FIG. 2B, the processor 232 generates a third image 540 comprising the first image 500 except for the selected portion 510, which is replaced by the determined portion of the second image 520. While some embodiments may result in a third image 540 with slightly different dimensions than the first image 500, the third image 540 should not substantially alter the size of the scene captured in the first image 500. In some embodiments, a distinct third image 540 may not be created. Rather, the first image 500 itself may be modified to replace the selected portion 510 of the first image 500 with the determined portion of the second image 520. Such an embodiment may require fewer memory resources as an unaltered copy of the first image 500 is not retained.

After the selected portion 510 of the first image 500 has been replaced by the determined portion of the second image 520, the method may finish, or it may return to an earlier step, such as block 322 or 324 to identify further portions of the image 500, 540 to be replaced or to capture additional images to be used to replace portions of the first image 500. Steps of the method 320 may be repeated iteratively until a desired image is obtained.

In one embodiment according to the methods 300, 320 shown in FIGS. 3A-B or other embodiments, the first blocks 302-306, 322-324 of the methods 300, 320 are performed according to embodiments described herein. At block 308, 326 the processor 212 automatically determines a portion of the second image and, at block 310, 328 replaces the selected portion of the first image with the determined portion of the second image.

In one such embodiment, the processor 212 identifies one or more interest points in the first image 400 and the second image 420. An interest point may comprise a particular feature within each image, such as a window, an eye, a corner of an object, SIFT (scale-invariant feature transform), SURF (speeded-up robust feature), ORB (oriented BRIEF (binary robust independent elementary features)), or FAST (features from accelerated segment test) image features (as are understood in the art), etc. The processor 212 then attempts to match interest points that are common to both images 400, 420 which may be used to align the two images 400, 420, such as by using a brute-force matching analysis or other algorithm, such as FLANK (fast approximate nearest neighbor) matching. For example the processor 212 may compute a dot product of coordinates for each interest point and attempt to match interest points in the respective images if the angle between interest points in the two images are less than a threshold.

After matching the interest points, the processor 212 estimates a homography matrix, such as by employing the matched interest points as well as random sample consensus (RANSAC) and a normalized direct linear transform. The processor 212 then transforms the second image 420 according to the homography matrix to create a transformed second image.

After creating the transformed second image, the selected portion of the first image is eroded, such as using a 5×5 square kernel to obtain an eroded selected portion, which the processor 212 then deletes from the first image 400. The (uneroded) selected portion is also dilated, such as using a 5×5 square kernel, to create a dilated selected portion. The processor 212 uses the dilated selected portion to determine and extract a portion of the second image 420. After the determined portion has been extracted from the second image 420, the processor 212 applies gain compensation to minimize the intensity difference of corresponding pixels from the first image 400 and the second image 420. Finally, at block 310, the processor 212 replaces the selected portion of the first image with the extracted portion of the second image to create the composite image 440. The processor 212 may further employ other manipulations when replacing the selected portion to provide a better quality composite image, such as multiband blending to avoid blur or cloning techniques like mean-value cloning or Poisson cloning.

Embodiments according to the present disclosure may have significant advantages over existing digital cameras and editing options on such cameras. For example, while a user may download images from a camera to a computer and perform image editing using software products such as Adobe® Photoshop®, in many cases, the user may not have immediate access to such a facility. Further, a user may not with to take and save multiple images of a scene for later editing. It may be more efficient and more desirable for a user to simply execute a method according to this disclosure immediately after taking a picture with an undesired feature, to save memory on a flash card or to quickly share the photo with friends and family. Further, photo editing products for conventional computers typically are expensive and may be difficult for an amateur to use. A digital camera or cellular phone with such integrated photo editing functionality provides significant benefits to a user and allows immediate correction of otherwise desirable digital photographs. Thus, a user may quickly and easily obtain a desired image without intensive manual editing or the use of a separate computer device.

### General

While the methods and systems herein are described in terms of software executing on various machines, the methods and systems may also be implemented as specifically-configured hardware, such a field-programmable gate array (FPGA) specifically to execute the various methods. For example, referring again to FIGS. 2A-B, embodiments can be implemented in digital electronic circuitry, or in computer hardware, firmware, software, or in a combination of thereof. In one embodiment, a device may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to “one embodiment” or “an embodiment” means that a particular feature, structure, operation, or other characteristic described in connection with the embodiment may be included in at least one implementation. The disclosure is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

That which is claimed is:

1. A portable image capture device comprising:
a display;
a memory configured to store images;
a camera in communication with the memory, the camera configured to capture images; and
a processor in communication with the memory and the display, the processor configured to:
receive a first image;
receive a selection of a portion of the first image, wherein the portion is less than all of the first image;
receive a second image, the second image comprising a different image than the first image;
determine a portion of the second image corresponding to the portion of the first image; and
replace the portion of the first image with the portion of the second image.

2. The portable image capture device of claim 1, wherein the display comprises a touch-sensitive display and the processor is configured to receive the selection of the portion of the first image based on a contact with the touch-sensitive display.

3. The portable image capture device of claim 1, wherein replacing the portion of the first image generates a third image, and wherein the processor is further configured to:
receive a selection of a portion of the third image;
receive a fourth image;
receive a selection of a portion of the fourth image corresponding to the portion of the third image;
determine a portion of the fourth image corresponding to the portion of the third image; and
replace the portion of the third image with the portion of the fourth image.

4. The portable image capture device of claim 1, wherein the processor is further configured to align the second image with the first image.

5. The portable image capture device of claim 4, wherein the processor is further configured to identify a first plurality of interest points in the first image and a second plurality of interest points in the second image, and to align the second image with the first image based at least in part on the first and second plurality of interest points.

6. The portable image capture device of claim 5, wherein the processor is further configured to:
compute a dot product of coordinates for the first and second interest points and to match the first and second interest points if an angle between the first and second interest points is less than a threshold;
estimate a homography matrix based at least in part on the first and second interest points;
transform the second image based on the homography matrix; and
extract the portion of the second image, wherein the second image comprises the transformed second image.

7. The portable image capture device of claim 1, wherein the processor is configured to determine a portion of the second image corresponding to the portion of the first image by:
displaying the first image;
displaying a part of the second image overlaid on an area corresponding to the portion of the first image; and
moving the part of second image based on an input received from an input device, the moving configured to overlay a new part of the second image on the area corresponding to the portion of the first image.

8. The portable image capture device of claim 7, wherein displaying the first image comprises displaying the portion of the first image as partially transparent.

9. The portable image capture device of claim 7, wherein displaying the first image comprises not displaying the portion of the first image.

10. The portable image capture device of claim 1, further comprising a second camera in communication with the memory and wherein the processor is configured to receive the first image from the camera and the second image from the second camera.

11. The portable image capture device of claim 10, wherein the camera is configured to capture the image substantially simultaneously with the second camera capturing the second image.

12. The portable image capture device of claim 1, wherein the device comprises a smartphone.

13. A method comprising:
receiving a first image by a portable image capture device;
receiving a selection of a portion of the first image by the portable image capture device, wherein the portion is less than all of the first image;
receiving a second image by the portable image capture device, the second image comprising a different image than the first image;
determining, by a portable image capture, a portion of the second image corresponding to the portion of the first image; and
replacing the portion of the first image with the portion of the second image by the portable image capture device.

14. The method of claim 13, further comprising:
capturing the first image using the portable image capture device; and
capturing the second image using the portable image capture device.

15. The method of claim 14, wherein the first image and the second image are captured substantially simultaneously.

16. The method of claim 14, wherein replacing the portion of the first image generates a third image, and further comprising:
receiving a selection of a portion of the third image by the portable image capture device;
capturing a fourth image using the portable image capture device;
receiving a selection of a portion of the fourth image corresponding to the portion of the third image portable image capture;
determining a portion of the fourth image corresponding to the portion of the third image by the portable image capture device; and
replacing the portion of the third image with the portion of the fourth image by the portable image capture device.

17. The method of claim 13, wherein determining a portion of the second image corresponding to the portion of the first image comprises:
displaying the first image by the portable image capture device;
displaying a part of the second image overlaid on an area corresponding to the portion of the first image by the portable image capture device; and
moving the part of second image based on an input received from an input device, the moving configured to overlay a new part of the second image on the area corresponding to the portion of the first image.

18. A portable image capture device comprising:
a display;
a memory configured to store images;
a first camera in communication with the memory, the first camera configured to capture images;
a second camera in communication with the memory, the second camera configured to capture images, the first and second cameras aligned to capture substantially stereoscopic images;
a processor in communication with the memory and the display, the processor configured to:
receive a first image from the first camera;
receive a second image from the second camera, the second image received substantially simultaneously as the first camera;
receive a selection of a portion of the first image, wherein the portion is less than all of the first image;
receive a second image, the second image comprising a different image than the first image;
determine a portion of the second image corresponding to the portion of the first image; and
replace the portion of the first image with the portion of the second image.

19. The portable image capture device of claim 18, wherein the display comprises a touch-sensitive display and the processor is configured to receive the selection of the portion of the first image based on a contact with the touch-sensitive display.

20. The portable image capture device of claim 18, wherein the processor is further configured to identify a first plurality of interest points in the first image and a second plurality of interest points in the second image, and to align the second image with the first image based at least in part on the first and second plurality of interest points.

21. The portable image capture device of claim 20, wherein the processor is further configured to:
compute a dot product of coordinates for the first and second interest points and to match the first and second interest points if an angle between the first and second interest points is less than a threshold;
estimate a homography matrix based at least in part on the first and second interest points;
transform the second image based on the homography matrix; and
extract the portion of the second image, wherein the second image comprises the transformed second image.

22. A method comprising:
capturing a first image using a first camera of a portable image capture device;
capturing a second image using a second camera by the portable image capture device, the second image captured substantially simultaneously with the first image, the first and second images providing substantially stereoscopic images;
receiving a selection of a portion of the first image by the portable image capture device, wherein the portion is less than all of the first image;
determining, by the portable image capture device, a portion of the second image corresponding to the portion of the first image; and
replacing the portion of the first image with the portion of the second image by the portable image capture device.

23. The method of claim 22, wherein the display comprises a touch-sensitive display and the processor is configured to receive the selection of the portion of the first image based on a contact with the touch-sensitive display.

24. The method of claim 22, wherein the processor is further configured to identify a first plurality of interest points in the first image and a second plurality of interest points in the second image, and to align the second image with the first image based at least in part on the first and second plurality of interest points.

25. The method of claim 24, wherein the processor is further configured to:
compute a dot product of coordinates for the first and second interest points and to match the first and second interest points if an angle between the first and second interest points is less than a threshold;
estimate a homography matrix based at least in part on the first and second interest points;
transform the second image based on the homography matrix; and
extract the portion of the second image, wherein the second image comprises the transformed second image.
